(19) United States
(12) Patent Application Publication
(10) Pub. No.: US 2026/0322140 A1
(43) Pub. Date: Oct. 15, 2026

(54) BATTERY BALANCING, AND ASSOCIATED UNITS, SYSTEMS, METHODS, COMPUTER-READABLE MEDIA, AND DEVICES

(71) Applicant: LiveView Technologies, LLC, American Fork, UT (US)

(72) Inventor: Jimmy R. Shumway, Pleasant Grove, UT (US)

(21) Appl. No.: 19/644,295

(22) Filed: Apr. 10, 2026

Related U.S. Application Data
(60) Provisional application No. 63/787,343, filed on Apr. 11, 2025.

(51) Int. Cl. H02J 7/52; H01M 10/42; H01M 10/48; H02J 7/00; H02J 7/80

(52) U.S. Cl. CPC H02J 7/52; H01M 10/425; H01M 10/482; H02J 7/80; H02J 7/855; H01M 2010/4271

(57) ABSTRACT

Systems and methods for managing battery banks are disclosed. A system may include a plurality of batteries, each battery associated with a battery management system (BMS) configured to control charge and discharge paths. The system further includes a controller configured to: monitor one or more battery parameters associated with the plurality of batteries; control protection states of the plurality of batteries; assign the plurality of batteries into one or more groups based on the monitored battery parameters; enable charging of batteries having relatively lower energy levels during a charging condition; enable discharging of batteries having relatively higher energy levels during a discharging condition; and iteratively modify the protection states of the plurality of batteries to reduce imbalance while the battery bank remains in operation. A mobile surveillance unit is also disclosed.

### CROSS-REFERENCE TO RELATED APPLICATION

This application claims the benefit of the filing date of U.S. Provisional Patent Application Ser. No. 63/787,343, filed Apr. 11, 2025, for “BATTERY BALANCING, AND ASSOCIATED UNITS, SYSTEMS, METHODS, COMPUTER-READABLE MEDIA, AND DEVICES,” the entire disclosure of which is hereby incorporated herein by this reference.

### TECHNICAL FIELD

This disclosure relates generally to battery balancing, and more specifically to parallel lithium battery balancing, and to related units, systems, methods, computer-readable media, and devices.

### BACKGROUND

Battery-powered systems are widely used across a variety of applications, including mobile platforms, stationary energy storage systems, and distributed electronic systems. Such systems often utilize multiple batteries connected in parallel to increase capacity, improve redundancy, or support modular deployment. In many applications, batteries include battery management systems (BMS) configured to monitor and protect the batteries during operation.

When batteries connected in parallel have differing states of charge or voltage levels, electrical current may flow between the batteries. In some cases, these currents may reach levels that trigger protective mechanisms or otherwise negatively impact system operation. Accordingly, there is a need for improved techniques for managing batteries connected in parallel.

### SUMMARY

Embodiments disclosed herein include a system for managing a battery bank. The system may include a plurality of batteries, each battery associated with a battery management system (BMS) configured to control charge and discharge paths of the respective battery. The system may also include a controller communicatively coupled to the plurality of batteries or the BMS associated therewith. The controller may be configured to: monitor one or more battery parameters associated with the plurality of batteries; control protection states of the plurality of batteries by selectively enabling or disabling charge paths and discharge paths of the batteries via the BMS; assign the plurality of batteries into one or more groups based on the monitored battery parameters; during a charging condition, enable charging of one or more batteries having relatively lower energy levels while restricting charging of one or more batteries having relatively higher energy levels; during the discharging condition, enable discharging of one or more batteries having relatively higher energy levels while restricting discharging of one or more batteries having relatively lower energy levels; and iteratively modify the protection states of the plurality of batteries to reduce imbalance while the battery bank remains in operation.

Additional embodiments include a method for managing a battery bank including a plurality of batteries, each associated with a battery management system (BMS), the method may include monitoring one or more battery parameters; assigning batteries into one or more groups based on the battery parameters. Further, the method may include selectively enabling or disabling charge paths and discharge paths of the batteries. The method may also include, during a charging condition, enabling charging of batteries having relatively lower energy levels while restricting charging of batteries having relatively higher energy levels. In addition, the method may include, during a discharging condition, enabling discharging of batteries having relatively higher energy levels while restricting discharging of batteries having relatively lower energy levels. Moreover, the method may include identifying a candidate battery and comparing a battery parameter of the candidate battery to a reference battery parameter. The method may also include enabling participation of the candidate battery when a difference between the parameters is within a threshold. Further, the method may include iteratively modifying protection states to reduce imbalance.

Other embodiments include a mobile surveillance unit including a battery bank including a plurality of batteries each associated with a battery management system (BMS). The mobile surveillance unit may also include a controller configured to balance the batteries by selectively enabling and restricting charge and discharge paths of the batteries via the BMS to control current flow during operation.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

FIG. 1 illustrates an example system for managing a plurality of batteries connected in parallel, in accordance with various embodiments described herein.

FIG. 2 illustrates an example battery management system (BMS) protection circuit associated with a battery, according to various embodiments of the disclosure.

FIG. 3 illustrates an example grouping of batteries for balancing, in accordance with various embodiments of the disclosure.

FIG. 4 illustrates an example process for managing batteries during a charging condition, according to various embodiments of the disclosure.

FIG. 5 illustrates an example process for managing batteries during a discharging condition, according to various embodiments of the disclosure.

FIG. 6 illustrates example operating states and transitions for a battery bank, in accordance with various embodiments of the disclosure.

FIG. 7 illustrates an example process for managing overcurrent conditions in a battery bank, in accordance with various embodiments of the disclosure.

FIG. 8 is a simplified perspective view of a surveillance unit, in accordance with various embodiments of the disclosure.

FIG. 9 depicts a system, according to various embodiments of the disclosure.

FIG. 10 illustrates an example system that may be used to implement embodiments of the disclosure.

FIG. 11 illustrates an example series of acts for . . . , in accordance with various embodiments of the disclosure.

### DETAILED DESCRIPTION

Battery systems that include multiple batteries connected in parallel may experience differences in state of charge, voltage, or internal characteristics among the batteries. Such differences may arise due to manufacturing variation, transportation conditions, replacement of individual batteries, or system events such as disconnection and reconnection following a fault.

When batteries having different states of charge are electrically connected in parallel, current may flow between the batteries as a system attempts to equalize voltage levels. In some circumstances, these currents may be relatively large and may persist for extended periods of time depending on the magnitude of the imbalance and the characteristics of the batteries.

Battery management systems (BMS) are commonly used to monitor battery conditions and to protect batteries from operating outside of defined limits. For example, a BMS may disable charge or discharge paths in response to overcurrent conditions, voltage thresholds, or other detected events. However, in some scenarios, current resulting from interactions between batteries within a battery bank may trigger such protection mechanisms, which may interrupt system operation.

In addition, existing approaches to managing imbalances between batteries may involve pre-conditioning batteries prior to connection, use of dedicated balancing hardware, or operational interruptions to allow equalization. These approaches may increase system complexity or reduce system availability.

Various embodiments disclosed herein relate to managing batteries connected in parallel by controlling operation of battery management systems (BMS) associated with individual batteries. The disclosed embodiments may be used to reduce or prevent undesired current flow between batteries and to facilitate balancing during normal system operation.

In some embodiments, the disclosed techniques may detect and/or prevent cross-connection of imbalanced batteries and utilize normal charge and discharge cycles to achieve balancing. These approaches may reduce or eliminate high currents and associated safety system activations. In some embodiments, batteries may be balanced while in service without interrupting system operation, without requiring additional hardware, and without requiring pre-conditioning of batteries prior to installation or replacement. In various embodiments, balancing may occur during charging, discharging, or both, depending on system configuration and operating conditions.

In some embodiments, batteries are balanced by dynamically controlling BMS protection states of individual batteries. A controller may monitor battery parameters, such as voltage and current, to detect imbalance conditions and selectively enable or disable charge and/or discharge paths of each battery using existing BMS switching circuitry. By controlling which batteries within a battery bank participate in charging or discharging, current flow within the battery bank may be managed to reduce differences in state of charge while avoiding excessive equalization currents that could otherwise trigger protection mechanisms.

In some embodiments, the controller may preferentially enable batteries having relatively lower energy levels to accept charge and may preferentially enable batteries having relatively higher energy levels to supply current. The relative energy levels may be determined based on one or more battery parameters, including voltage, current, state of charge, or combinations thereof.

In some embodiments, the controller may determine an operating condition of the battery bank, such as charging, discharging, or idle, based on measured or reported currents. The controller may communicate with one or more BMS devices via wired or wireless interfaces and/or influence BMS operation by manipulating external electrical conditions. In some embodiments, the controller may influence operation of one or more BMS devices without direct communication by modifying external electrical conditions associated with the battery bank. For example, the controller may adjust one or more of a voltage level, current level, or load condition applied to the battery bank to cause a BMS to transition between protection states. In this manner, the controller may indirectly control participation of individual batteries in charging or discharging without transmitting explicit control commands to the BMS. Based on monitored parameters, batteries may be dynamically grouped and controlled to preferentially accept or supply energy, such that batteries with relatively lower energy levels are charged and batteries with relatively higher energy levels are discharged while limiting current flow between batteries. The controller may further sequence changes in battery protection states to maintain continuous power delivery and progressively reduce imbalance over time.

In various embodiments, a system includes a plurality of batteries connected in parallel to form a battery bank. Each battery may be associated with (e.g., include) a BMS configured to monitor one or more battery parameters, such as voltage and current, and to selectively control charge and discharge paths of the battery. The BMS may include one or more controllable switching elements that enable or disable current flow into or out of the battery.

In some embodiments, a system monitors battery parameters for each battery in a battery bank and determines whether an imbalance condition exists among the batteries. The imbalance condition may be based on differences in voltage, state of charge, current, or other parameters. In response to detecting the imbalance condition, the system may selectively control operation of a BMS of one or more batteries to manage current flow between the batteries.

For example, in some embodiments, the system may selectively enable or disable charge and/or discharge paths of individual batteries such that current flow into or out of the batteries is controlled during normal charge or discharge operation. By controlling which batteries are permitted to accept charge or supply current at a given time, the system may reduce differences in state of charge between the batteries over time while limiting current that would otherwise flow directly between batteries.

In some embodiments, a system may dynamically assign batteries to one or more groups based on monitored battery parameters. For example, batteries having relatively lower voltages may be assigned to a first group, while batteries having relatively higher voltages may be assigned to a second group. The system may then control BMS operation such that batteries in the first group are preferentially charged and/or batteries in the second group are preferentially discharged.

The assignment of batteries to groups may be updated over time based on changes in the monitored parameters. As battery voltages converge, batteries may be transitioned between groups and corresponding BMS control states may be modified. In this manner, the system may iteratively reduce imbalance among the batteries while maintaining operation of the battery bank.

In some embodiments, each battery may be operated in one of a plurality of protection states, including a fully enabled state in which both charge and discharge paths are enabled, a fully disabled state in which both charge and discharge paths are disabled, a charge-enabled state in which only a charge path is enabled, and a discharge-enabled state in which only a discharge path is enabled. The system may transition batteries between these states to control current flow within the battery bank.

For example, during a charging condition, a system may enable charge paths for selected batteries while restricting charge paths for other batteries based on relative voltage levels. Similarly, during a discharging condition, the system may enable discharge paths for selected batteries while restricting discharge paths for other batteries. By selectively controlling these states, the system may manage current distribution within a battery bank and facilitate balancing.

In some embodiments, the disclosed techniques enable balancing of batteries during normal system operation without requiring dedicated balancing hardware or interruption of system functionality. The system may operate continuously to monitor battery conditions and adjust control states (e.g., BMS control states) to reduce imbalance while avoiding conditions that would otherwise trigger protection mechanisms.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

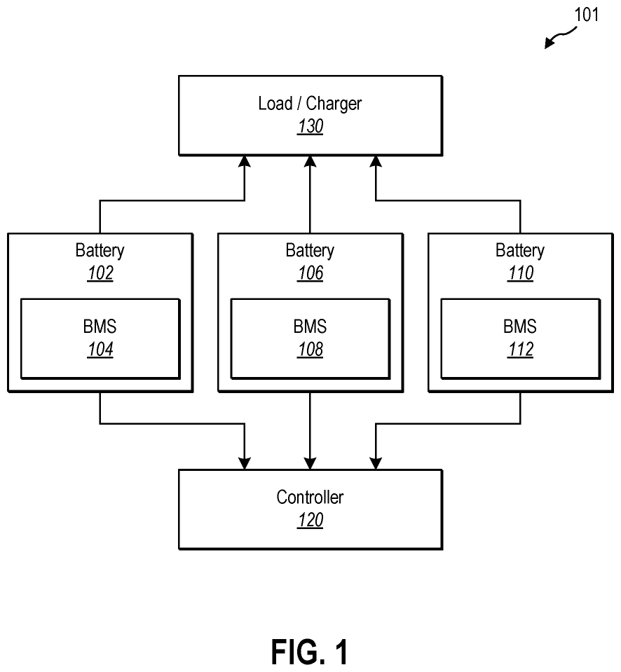

FIG. 1 illustrates an example system 100 for managing a plurality of batteries connected in parallel, in accordance with various embodiments described herein. The system 100 may include a battery bank 101 including a plurality of batteries 102, 106, and 110, each associated with a respective battery management system (BMS) 104, 108, and 112. Each BMS may be configured to monitor battery parameters and control operation of the associated battery, including selectively enabling or disabling charge and/or discharge paths.

The batteries 102, 106, and 110 may be electrically coupled to a common bus and configured to provide power to, and/or receive power from, a load and/or charging source 130. The load and/or charging source 130 may include one or more electrical loads, one or more charging devices, or combinations thereof.

A controller 120 may be communicatively coupled to each of the BMS 104, 108, and 112. The controller 120 may be configured to receive battery parameters (e.g., voltage, current, state of charge) and to control operation of the BMS to selectively manage current flow into and out of the batteries. In some embodiments, the controller 120 may communicate with the BMS via wired and/or wireless communication interfaces. The controller 120 may further be configured to determine operating conditions of the battery bank 101 (e.g., charging, discharging, or idle) and to dynamically control protection states of the batteries to facilitate balancing while maintaining operation of the system. In some embodiments, the controller 120 may also be coupled to the load and/or charging source 130.

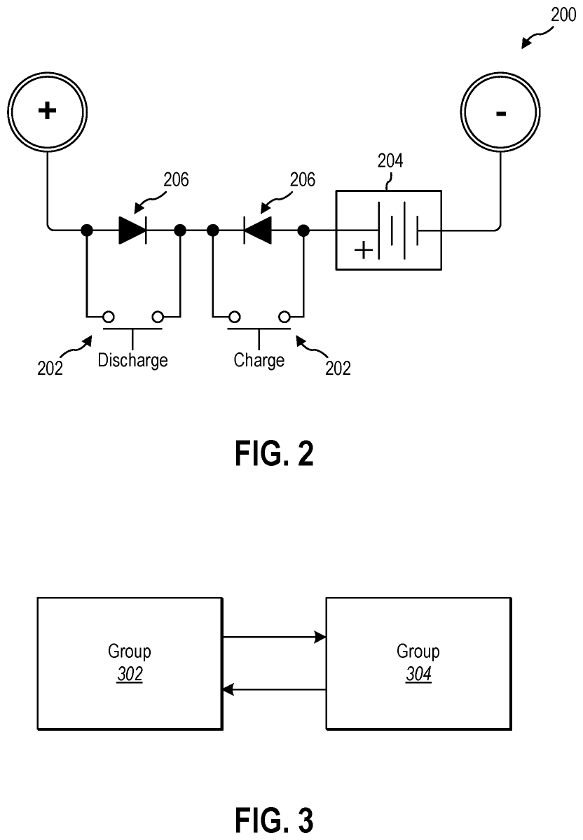

FIG. 2 illustrates an example BMS protection circuit 200 associated with a battery, according to various embodiments of the disclosure. The protection circuit 200 may include one or more switching elements 202 configured to control current flow into and out of a battery cell 204.

In some embodiments, the switching elements 202 may include field effect transistors (FETs) arranged in a back-to-back configuration to selectively permit or restrict bidirectional current flow. The protection circuit 200 may define a discharge path and a charge path, each of which may be independently controllable via the switching elements 202.

In some embodiments, the protection circuit 200 may further include one or more diode paths that allow current flow in a single direction when corresponding switching elements are disabled. Through control of the switching elements 202, the BMS protection circuit 200 may be configured to operate in a plurality of protection states, including: a fully enabled state (charge and discharge paths enabled); a fully disabled state (charge and discharge paths disabled); a charge-enabled state (charge path enabled, discharge path restricted); and a discharge-enabled state (discharge path enabled, charge path restricted). These states may be selectively controlled by the controller (e.g., controller 120 of FIG. 1) to regulate participation of the battery in charging and discharging.

FIG. 3 illustrates an example grouping of batteries for balancing, in accordance with various embodiments of the disclosure. Batteries may be dynamically assigned to a first group 302 or a second group 304 based on one or more monitored battery parameters, such as voltage, current, or state of charge.

In some embodiments, the first group 302 may include batteries having relatively lower voltage or energy levels, and the second group 304 may include batteries having relatively higher voltage or energy levels. A controller (e.g., the controller 120) may control operation of BMS associated with the batteries such that batteries in the first group 302 are preferentially charged and/or batteries in the second group 304 are preferentially discharged. The assignment of batteries to groups 302 and 304 may be updated over time based on changes in battery parameters, enabling iterative balancing of the battery bank.

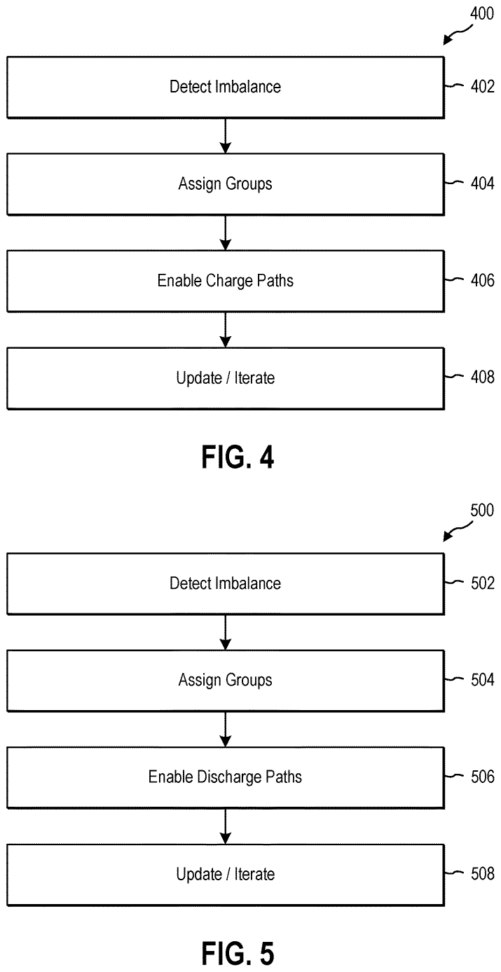

FIG. 4 illustrates an example process 400 for managing batteries of a battery bank during a charging condition, according to various embodiments of the disclosure. The process 400 may include detecting an imbalance condition among a plurality of batteries (402), assigning the batteries to one or more groups based on one or more battery parameters (404), and selectively enabling charge paths for one or more batteries (406). The process 400 may further include updating or iterating (408) the grouping and control of the batteries over time to progressively reduce imbalance while the battery bank remains in operation.

In some embodiments, when the battery bank is operating in a charging condition and an imbalance condition is detected, a controller (e.g., the controller 120 of FIG. 1) may selectively control participation of individual batteries in charging based on one or more battery parameters, such as voltage, current, and/or state of charge. Batteries that are currently configured in a charge-enabled state or a fully enabled state may be designated as part of a first group (e.g., the group 302 or the group 304; see FIG. 3), while remaining batteries may be designated as part of a second group (e.g., the other of the group 302 or the group 304). The controller may initially restrict charging of batteries in the second group until certain conditions are satisfied.

In some embodiments, the controller may determine a reference value, such as a reference voltage, based on one or more batteries in the first group. For example, the reference voltage may correspond to a lowest voltage among the batteries in the first group. The controller may then identify a candidate battery from the second group, such as a battery having a lowest voltage within the second group. The voltage of the candidate battery may be compared to the reference voltage to determine whether a difference between the voltages satisfies a predefined condition, such as being within a threshold associated with safe cross-connection or acceptable current flow.

If the voltage difference exceeds the threshold, the controller may delay enabling of the candidate battery and may optionally initiate a transition sequence. The transition sequence may include one or more intermediate changes in protection states of one or more batteries to prevent abrupt current flow and to maintain stable operation of the battery bank.

If the voltage of the candidate battery is within the threshold relative to the reference voltage, the controller may modify a protection state of the candidate battery to a fully enabled state, thereby allowing the candidate battery to accept charge. The candidate battery may then be reassigned to the first group. This process may be repeated iteratively, with additional candidate batteries being evaluated and transitioned, until a desired condition is achieved, such as all batteries being configured in a fully enabled state or a difference in battery parameters falling below a threshold. At this point, the battery bank may be considered to be substantially balanced.

In some embodiments, the controller may monitor for error conditions during the process. For example, an error condition may be identified if all batteries are configured to permit charging, yet one or more batteries are not in a fully enabled state, indicating a potential fault, communication issue, or protection condition within a battery or associated BMS. In response to detecting such an error condition, the system may, for example only, generate an alert, log diagnostic information, and/or modify operation of one or more batteries.

FIG. 5 illustrates an example process 500 for managing batteries of a battery bank during a discharging condition, according to various embodiments of the disclosure. The process 500 may include detecting an imbalance condition among a plurality of batteries (502), assigning the batteries to one or more groups based on one or more battery parameters (504), and selectively enabling discharge paths for one or more batteries (506). The process 500 may further include iteratively updating or repeating (508) the grouping and control of the batteries to progressively reduce imbalance while the battery bank continues to supply power.

In some embodiments, when a battery bank is operating in a discharging condition and an imbalance condition is detected, a controller (e.g., the controller 120 of FIG. 1) may selectively control participation of individual batteries in supplying current based on one or more battery parameters, such as voltage, current, and/or state of charge. Batteries that are configured in a discharge-enabled state or a fully enabled state may be designated as part of a first group (e.g., the group 302 or the group 304; see FIG. 3), while remaining batteries may be designated as part of a second group (e.g., the other of the group 302 or the group 304). The controller may initially restrict or limit discharge from batteries in the second group until one or more conditions are satisfied.

In some embodiments, the controller may determine a reference value, such as a reference voltage, based on one or more batteries in the first group. For example, the reference voltage may correspond to a highest voltage among the batteries in the first group. The controller may then identify a candidate battery from the second group, such as a battery having a highest voltage within the second group. The voltage of the candidate battery may be compared to the reference voltage to determine whether a difference between the voltages satisfies a predefined condition, such as being within a threshold associated with safe current sharing or acceptable current flow.

If the voltage difference exceeds the threshold, the controller may delay enabling of the candidate battery and may optionally initiate a transition sequence. The transition sequence may include one or more intermediate adjustments to protection states of one or more batteries to reduce abrupt changes in current and maintain stable system operation.

If the voltage of the candidate battery is within the threshold relative to the reference voltage, the controller may modify a protection state of the candidate battery to a fully enabled state, thereby allowing the candidate battery to supply current to the system. The candidate battery may then be reassigned to the first group. This process may be repeated iteratively, with additional candidate batteries being evaluated and transitioned, until a desired condition is achieved, such as all batteries being configured in a fully enabled state or a difference in battery parameters falling below a threshold. At this point, the battery bank may be considered to be substantially balanced.

In some embodiments, the controller may monitor for error conditions during the process. For example, an error condition may be identified if all batteries are configured to permit discharging, yet one or more batteries are not in a fully enabled state, indicating a potential fault, protection condition, or communication issue associated with a battery or corresponding BMS. In response to detecting such an error condition, the system may generate an alert, log diagnostic information, and/or modify operation of one or more batteries.

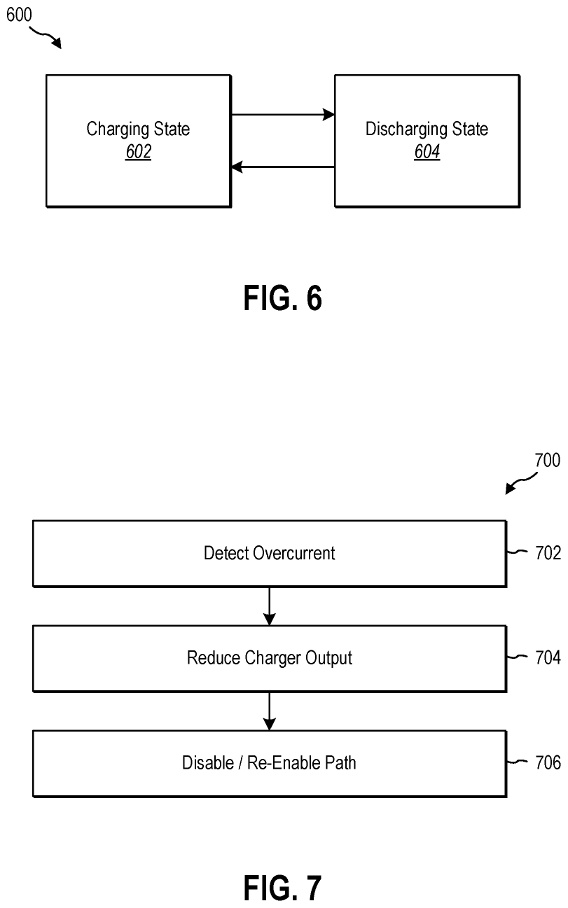

FIG. 6 illustrates example operating states and transitions for a battery bank, in accordance with various embodiments of the disclosure. In some embodiments, a system (e.g., system 100 of FIG. 1) may operate in a charging state 602 or a discharging state 604 and may transition between these states based on one or more conditions. The conditions may include measured electrical characteristics, such as current over time, and the state transitions may be used to coordinate control of battery charge and discharge paths.

In some embodiments, a controller (e.g., the controller 120 of FIG. 1) may determine whether a battery bank is in a charging state or a discharging state based on measured current over time. The controller may monitor a net current associated with the battery bank and may maintain a history of current measurements over a defined time window. The direction and magnitude of current over time may be used to determine whether the battery bank is predominantly receiving energy or supplying energy.

If a threshold number or proportion of recent current measurements indicate current flowing out of the battery bank, the controller may determine that the system is operating in a discharging state and may transition from the charging state 602 to the discharging state 604. Conversely, if a threshold number or proportion of recent measurements indicate current flowing into the battery bank, the controller may determine that the system is operating in a charging state and may transition from the discharging state 604 to the charging state 602. In some embodiments, threshold conditions may include time-based filtering, averaging, or hysteresis to prevent rapid oscillation between states.

In some embodiments, determination of the operating state may be based on one or more sources of current information. For example, the controller may aggregate currents reported by individual battery management systems (BMS), measure a total current associated with the battery bank using one or more sensors, and/or estimate current based on known energy sources and loads coupled to the battery bank.

In some embodiments, when transitioning from the discharging state 604 to the charging state 602 and an imbalance condition is present, the controller may perform a transition sequence to safely reconfigure battery participation. The controller may identify a battery having a lowest voltage (or lowest energy level) and designate that battery as part of a first group (e.g., the group 302 or the group 304; see FIG. 3).

The controller may include in the first group additional batteries having voltages within a predefined threshold of the lowest voltage. Remaining batteries may be designated as part of a second group (e.g., the other of the group 302 or the group 304). This grouping may be used to stage the transition into the charging condition while limiting undesired current flow between batteries.

In some embodiments, batteries in the first group may initially be configured to a discharge-only protection state, and batteries in the second group may be configured to a charge-only protection state. This configuration may reduce the likelihood of abrupt current flow between batteries during the transition. Subsequently, the controller may modify the protection state of batteries in the first group to a fully enabled state, thereby allowing those batteries to participate in both charging and discharging as the system stabilizes in the charging condition. Following completion of the transition sequence, the controller may designate the battery bank as operating in the charging state 602 and may continue balancing operations as described in connection with FIG. 4.

In some embodiments, when transitioning from the charging state 602 to the discharging state 604 and an imbalance condition is present, the controller may perform a transition sequence to safely configure batteries for supplying current. The controller may identify a battery having a highest voltage (or highest energy level) and designate that battery as part of a first group (e.g., the group 302 or the group 304; see FIG. 3).

The controller may include in the first group additional batteries having voltages within a predefined threshold of the highest voltage. Remaining batteries may be designated as part of a second group (e.g., the other of the group 302 or the group 304). This grouping may be used to prioritize batteries that are best suited to supply current while limiting undesired current flow.

In some embodiments, batteries in the second group may be configured to a discharge-only protection state (or otherwise restricted from supplying current), while batteries in the first group may be configured to a fully enabled state, thereby enabling those batteries to supply current to the system. The controller may subsequently adjust protection states as needed to maintain stable operation. Following completion of the transition sequence, the controller may designate the battery bank as operating in the discharging state 604 and may continue balancing operations as described in connection with FIG. 5.

In some embodiments, the controller may sequence changes in protection states of the plurality of batteries such that at least one battery remains enabled to provide power to a load during transitions between operating conditions. This sequencing may allow the system to maintain continuous power delivery while reconfiguring battery participation and balancing the battery bank.

FIG. 7 illustrates an example process 700 for managing overcurrent conditions in a battery bank, in accordance with various embodiments of the disclosure. The process 700 may include detecting an overcurrent condition (702) and performing one or more corrective actions (704, 706) to maintain operation within defined limits. Corrective actions may include adjusting a charging current, modifying battery participation, and/or temporarily disabling and re-enabling one or more current paths.

In some embodiments, a controller (e.g., the controller 120 of FIG. 1) may monitor current associated with each battery and/or a total current of the battery bank. The monitoring may be continuous or periodic and may include comparing measured currents to one or more predefined thresholds for charging and discharging. An overcurrent condition may be identified when a current associated with a battery or the battery bank exceeds a corresponding threshold for a defined duration.

In some embodiments, when an overcurrent condition is detected during charging, the controller may determine whether a particular battery is disproportionately accepting charge relative to other batteries. If a single battery is primarily responsible for the overcurrent condition, the controller may reduce an output current of a charging source to decrease the charge current.

If the current does not decrease to a safe level within a predefined time period, the controller may temporarily disable a charging path for the battery, for example by modifying a protection state of the battery management system (BMS), and subsequently re-enable the charging path. This temporary disable/enable sequence may be used to reset current conditions and encourage redistribution of charge current among multiple batteries.

The controller may repeat the above process iteratively until the charge current is distributed across multiple batteries and the overcurrent condition is mitigated. In some embodiments, the controller may also adjust grouping of batteries or modify protection states of additional batteries to facilitate sharing of charge current.

In some embodiments, when an overcurrent condition is detected during discharging, the controller may determine whether the condition is associated with an external fault or an internal imbalance within the battery bank. For example, if a magnitude of the total current of the battery bank exceeds a predefined maximum discharge threshold, the condition may be identified as an external fault, such as a short circuit or excessive load demand.

If the magnitude of the total current is below the maximum discharge threshold, the controller may determine that the overcurrent condition is internal to the battery bank, such as being caused by uneven current sharing among batteries. In response, the controller may modify protection states of one or more batteries to redistribute current. For example, a battery experiencing a highest current may be temporarily restricted (e.g., placed in a discharge-limited or discharge-disabled state), while one or more additional batteries may be enabled or transitioned to a fully enabled state to share the load.

The controller may iteratively adjust protection states and battery grouping until the current is more evenly distributed and the overcurrent condition is reduced. In some embodiments, the controller may log the condition, generate an alert, and/or store diagnostic information for later analysis.

In some embodiments, the controller may coordinate overcurrent management with the balancing processes described in connection with FIGS. 4-6. For example, adjustments to protection states during overcurrent mitigation may also contribute to balancing of battery parameters over time. The controller may prioritize maintaining safe operating conditions while continuing to facilitate balancing where possible.

In some embodiments, the systems and methods described herein may be implemented in a variety of applications, including mobile or stationary systems that utilize battery banks. As a non-limiting example, a surveillance unit may include a battery bank managed in accordance with the techniques described herein.

A surveillance unit may include a mobile or portable system configured to monitor a designated area and may include one or more sensors, cameras, lighting elements, and processing components. The battery management techniques described herein may be used to improve reliability and operational efficiency of such systems. It should be understood that this example is provided for illustration and that the disclosed techniques are not limited to surveillance applications.

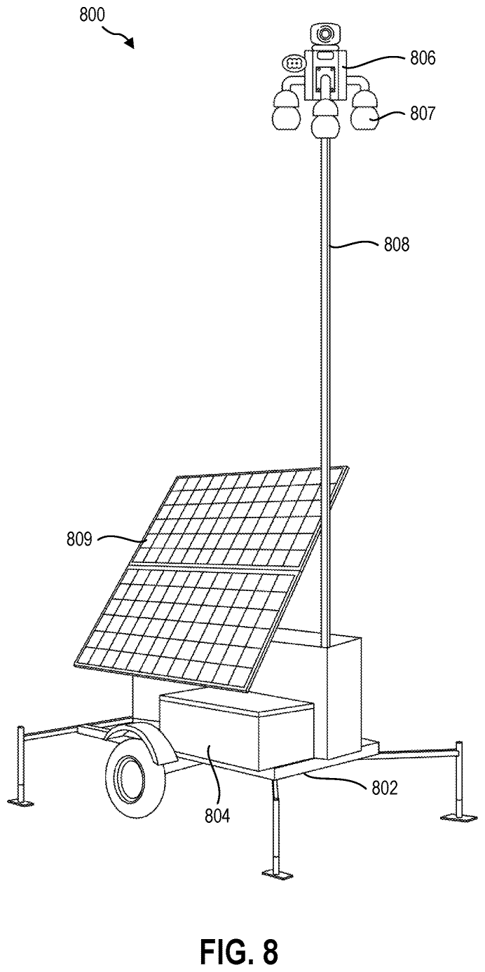

FIG. 8 is a simplified perspective view of a surveillance unit 800, in accordance with various embodiments of the disclosure. The surveillance unit 800, which may also be referred to herein as a “mobile unit,” a “mobile surveillance unit,” a “mobile security unit,” an “MSU,” a “live unit,” a “physical unit,” or some variation thereof, may be configured to be positioned in an environment (e.g., a parking lot, a roadside location, a construction zone, a concert venue, a sporting venue, a school campus, without limitation). In some embodiments, the surveillance unit 800 includes one or more sensors (e.g., cameras, weather sensors, motion sensors, noise sensors, without limitation) and one or more output devices (e.g., lights, speakers, electronic displays, without limitation). The surveillance unit 800 may also include at least one storage device (e.g., internal flash media, a network-attached storage device, or any other suitable electronic storage device), which may be configured for receiving and storing data (e.g., video, images, audio, without limitation) captured by one or more sensors of the surveillance unit 800.

In some embodiments, the surveillance unit 800 includes a mobile security/surveillance unit. For example, the mobile surveillance unit may be configured to be transported to a desired location and deployed at the desired location. In these and other embodiments, the surveillance unit 800 may include a portable trailer 802, a storage box 804, and a mast 808 coupled to a head unit 806 which may include for example, one or more batteries, one or more cameras, controllers/processors or other electronics, one or more lights, one or more speakers, and/or one or more microphones. In some embodiments, the surveillance unit 800 may be a stationary surveillance unit.

During transport or storage of the surveillance unit 800, one or more components of the surveillance unit 800 may be removed from the surveillance unit 800, the mast 808, or the head unit 806. In some embodiments, the mast 808 is an extendable or deployable mast and may be extended or deployed at the time of deployment of the surveillance unit 800 in a field location. The mast 808 supports the head unit 806 and may include an extendable pole that is retracted while the surveillance unit 800 is being transported and extended when the surveillance unit 800 is secured at a deployed location. Upon deployment of the surveillance unit 800, the mast 808 may be connected to the trailer 802 and/or storage box 804 at a first end, and the head unit 806 may be positioned at an elevated position at a second, opposite end of mast 808. According to some embodiments, the first end of mast 808 may be proximate to the storage box 804 and the second, opposite end of mast 808 may be proximate, and possibly adjacent, to the head unit 806. More specifically, in some embodiments, the head unit 806 may be coupled to the mast 808 at an end opposite to an end of the mast 808 proximate to storage box 804.

The portable trailer 802 may be configured to facilitate transporting the surveillance unit 800. The storage box 804 may be configured to facilitate storage of one or more components of the surveillance unit 800, such as one or more primary batteries. The storage box 804 may also be configured to carry one or more power sources in addition to the primary batteries, such as generators (e.g., fuel cell generators).

In some examples, the surveillance unit 800 may include one or more primary batteries (e.g., within storage box 804) and one or more secondary batteries (e.g., within the head unit 806). In these embodiments, a primary battery positioned in the storage box 804 may be coupled to a load and/or a secondary battery positioned within the head unit 806 via, for example, a cord reel.

In some embodiments, the surveillance unit 800 includes at least one computing device and/or other electronics powered by the one or more batteries. In some embodiments, valuable devices (e.g., hardware) may be securely housed in storage box 804 and in data communication with the head unit 806. For example, the head unit 806 may include one or more sensors or one or more output devices, and a computing device (e.g., in the head unit 806 or the storage box 804) may receive data from the one or more sensors and/or transmit instructions to the one or more output devices. As described above, in some embodiments, the storage box 804 securely houses one or more hardware storage devices. The one or more storage devices may be in data communication with and/or integrated with the one or more computing devices.

In some embodiments, the surveillance unit 800 may also include one or more power sources and/or power supplies. For example, the surveillance unit 800 may include or be in electrical communication with one or more solar panels 809, which may provide power to one or more batteries of unit. More specifically, according to some embodiments, one or more solar panels 809 may provide power to a primary battery within storage box 804. In some embodiments, the surveillance unit 800 may also include other power sources, such as one or more generators (e.g., fuel cell generator or other power generators). For example, storage box 804 may include a fuel cell generator and/or another power generator. As described in additional detail herein, the solar panels 809 may be in operable (e.g., electric) communication with one or more batters of the surveillance unit 800.

The head unit 806 may include one or more sensors, visible spectrum cameras, thermal cameras, infrared (IR) cameras, IR sensors, and processing components (e.g., computing devices) that capture, process, and store surveillance data. In some embodiments, the head unit 806 includes one or more cameras 807. The cameras 807 may each include one or more thermal cameras, one or more visible cameras, an ultraviolet camera, a hyperspectral camera, and/or one or more other cameras. Non-limiting examples of thermal cameras include an infrared (IR) camera, a short-wave infrared (SWIR) camera, a long-wave infrared (LWIR) camera, a LWIR detection sensor, or another type of infrared camera. In some embodiments, the visible cameras include red green blue (RGB) cameras. In some embodiments, at least one of (e.g., each of) the cameras 807 includes a visible camera (e.g., an RGB camera) and a thermal camera and may be referred to as a “bi-spectral camera.” In some embodiments, the cameras 807 are visible spectrum cameras.

The head unit 806 may include hardware and software computing elements that allow the surveillance unit 800 to serve as an edge unit. In some embodiments, the head unit 806 also includes input and output devices, such as one or more lights (e.g., flood lights, strobe lights, LED lights, or other lights), speakers (e.g., loudspeakers, one-way speakers, two-way public address (PA) speaker systems, or any other suitable speaker), microphones, display devices (e.g., digital display devices), and/or other suitable output devices. In some embodiments, some components of the head unit 806 may also be located elsewhere on the surveillance unit 800, such as in the storage box 804. As described above, the head unit 806 may also include batteries or other power components. In some embodiments, the head unit 806 is referred to as a “live unit.”

In operation, the cameras 807 capture image data and/or video data comprising images and/or videos of the surveillance unit 800 and/or of a proximity of the surveillance unit 800. Based on the image data and/or the video data captured by the camera(s) 807, an alert system of the surveillance unit 800 may activate one or more alert protocols, which may include lights, speakers, and/or one or more other output devices on the surveillance unit 800. The head unit 800 may further include one or more sensors configured to capture data indicative of one or more conditions in the environment proximate the surveillance unit 800.

As noted above, various embodiments relate to battery balancing, and more specifically to devices, systems, methods, computer-readable media for balancing a number of batteries (e.g., of a device, system, and/or unit, such as a mobile surveillance unit).

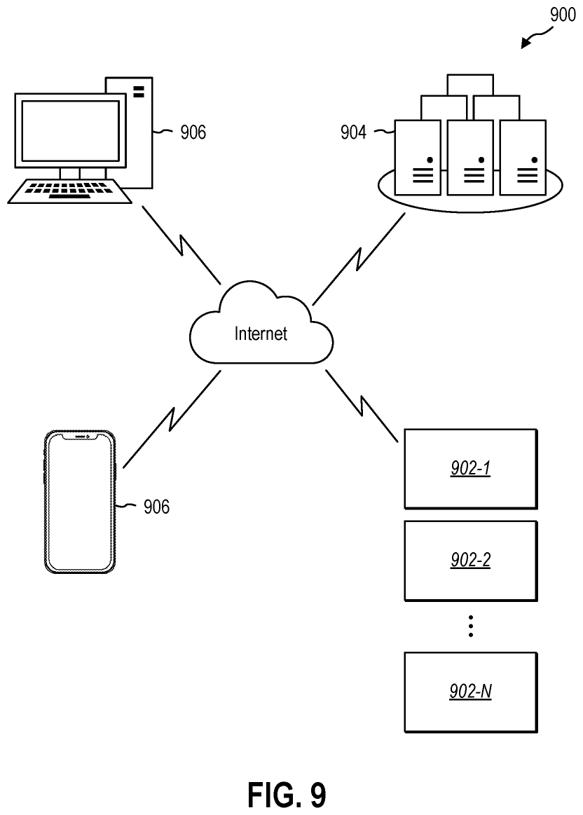

FIG. 9 depicts a system 900, in accordance with various embodiments of the disclosure. System 900 includes one or more mobile units 902 (e.g., mobile units 902_1 902_N), a server 904, and one or more devices 906. In one non-limiting example, each mobile unit 902 includes surveillance unit 800 (see FIG. 8), server 904 may include a cloud server or any other server, and device(s) 904 may include an electronic device, such as a front-end device (e.g., a user device (e.g., mobile phone, tablet, etc.), a desktop computer, or any other suitable electronic device (e.g., including a display)). According to various embodiments, each of server 904 and device(s) 906 may be remote from mobile unit 902. Further, for example, server 904 may include a cloud-based processor.

According to various embodiments of the disclosure, each mobile unit 902, which may include a modem, may be within a first location (a “camera location” or a “remote location”), and server 904 may be within a second location, remote from the camera location. In addition, in at least some examples, electronic device 906 may be remote from the camera location and/or server 904. As will be appreciated by a person having ordinary skill in the art, system 900 may be modular, expandable, and/or scalable. It is noted that according to various embodiments, various devices of system 900 may be configured to communicate via one or more metered connections (e.g., cellular, satellite, etc.). In some embodiments, at least one mobile unit 902 may include a number of batteries, which may be balanced in accordance with various embodiments disclosed herein.

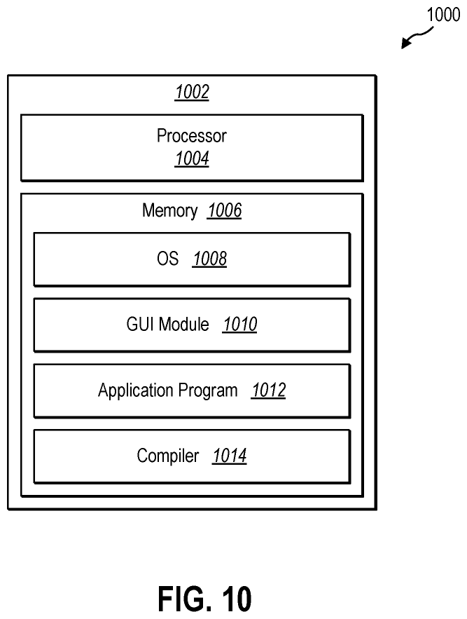

FIG. 10 illustrates a system 1000 that may be used to implement embodiments of the disclosure. System 1000 may include a computer 1002 that comprises a processor 1004 and memory 1006. For example only, and not by way of limitation, computer 1002 may include a workstation, a laptop, or a hand-held device such as a cell phone or a personal digital assistant (PDA), a server (e.g., server 904), a computer, or any other processor-based device known in the art. In one embodiment, computer 1002 may be operably coupled to a display (not shown in FIG. 10), which presents images to the user via a GUI. As will be appreciated, computer 1002 may include one or controllers including one or more operating systems, which may be configured and/or updated in accordance with various embodiments disclosed herein.

Generally, computer 1002 may operate under control of an operating system 1008 stored in memory 1006, and interface with a user to accept inputs and commands and to present outputs through a GUI module 1010. Although GUI module 1010 is depicted as a separate module, the instructions performing the GUI functions may be resident or distributed in the operating system 1008, a program 1012, or implemented with special purpose memory and processors. Computer 1002 may also implement a compiler 1014 that allows a program (e.g., code) 1012 written in a programming language to be translated into processor 1004 readable code. After completion, program 1012 may access and manipulate data stored in memory 1008 of computer 1002 using the relationships and logic that are generated using compiler 1014.

Further, operating system 1008 and program 1012 may include instructions that, when read and executed by computer 1002, may cause computer 1002 to perform the steps necessary to implement and/or use various embodiments of the disclosure. Program 1012 and/or operating instructions may also be tangibly embodied in memory 1006 and/or data communications devices, thereby making a computer program product or article of manufacture according to an embodiment of the present disclosure. As such, the term “program” as used herein is intended to encompass a computer program accessible from any computer readable device or media. Program 1012 may exist on an electronic device (e.g., electronic device 906; see FIG. 9), a server (e.g., server 904; see FIG. 9), a mobile unit (e.g., mobile unit 202; see FIG. 9), and/or another device. Furthermore, portions of program 1012 may be distributed such that some of program 1012 may be included on a computer readable media within an electronic device (e.g., electronic device 906), some of program 1012 may be included on a computer readable media on a server (e.g., server 904), some of program 1012 may be included on a computer readable media on a surveillance unit (e.g., unit 902), and/or some of program 1012 may be included on a computer readable media on another device. In some embodiments, program 1012 may be configured to run on electronic device 906, server 904, unit 902, another computing device, or any combination thereof. As a specific example, program 1012 may exist on server 904 and/or unit 902 and may be accessible to a user via electronic device 906.

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and a person having ordinary skill will understand that various embodiments may be applicable to other systems and devices, such as stationary units (e.g., a unit coupled to a stationary pole (e.g., a light pole), a structure (e.g., of a business or a residence), a tree, etc.). Embodiments of the disclosure will now be explained with reference to the accompanying drawings.

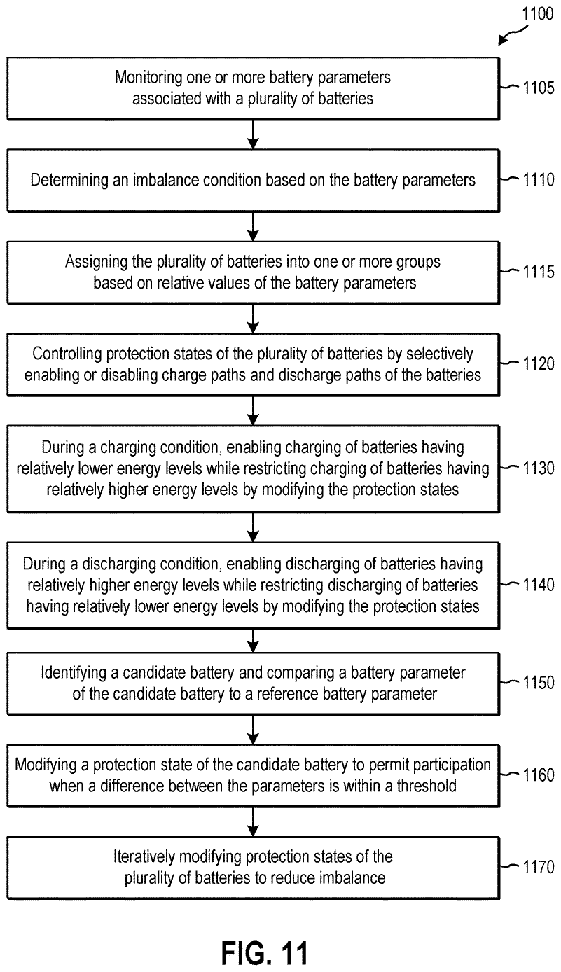

FIG. 11 illustrates an example series of acts 1100 for managing a battery bank including a plurality of batteries, in accordance with various embodiments of the disclosure. While FIG. 11 illustrates acts according to one or more embodiments, alternative embodiments may omit, add to, reorder, and/or modify any of the acts shown in FIG. 11. The acts of FIG. 11 may be performed as part of a method. Alternatively, a non-transitory computer-readable medium can include instructions thereon that, when executed by one or more processors, cause a device to perform the acts of FIG. 11. In still further embodiments, a system can perform the acts of FIG. 11. In some embodiments, one or more acts of acts 1100 may be initiated in response to detecting a charging condition or a discharging condition of the battery bank.

As shown in FIG. 11, the series of acts 1100 includes an act 1105 of monitoring one or more battery parameters associated with a plurality of batteries. For example, a controller may monitor battery parameters including voltage, current, state of charge, temperature, or combinations thereof. In some embodiments, the battery parameters may be obtained from battery management systems (BMS) associated with the batteries via one or more communication interfaces. In other embodiments, one or more battery parameters may be independently measured using sensors coupled to the battery bank. Monitoring may be performed continuously or periodically.

As further shown in FIG. 11, the series of acts 1100 includes an act 1110 of determining an imbalance condition based on the battery parameters. For example, the controller may determine that an imbalance condition exists when one or more battery parameters differ between batteries by more than a predefined amount. In some embodiments, the imbalance condition may be based on differences in voltage, state of charge, or other energy-related parameters among the plurality of batteries.

As further shown in FIG. 11, the series of acts 1100 includes an act 1115 of assigning the plurality of batteries into one or more groups based on relative values of the battery parameters. For example, batteries having relatively lower values of a battery parameter may be assigned to a first group and batteries having relatively higher values may be assigned to a second group. In some embodiments, grouping may include identifying one or more batteries having an extreme value (e.g., lowest or highest) and grouping additional batteries based on whether their respective parameters are within a threshold of the extreme value.

As further shown in FIG. 11, the series of acts 1100 includes an act 1120 of controlling protection states of the plurality of batteries by selectively enabling or disabling charge paths and discharge paths of the batteries via a BMS. For example, a controller may control switching elements of the BMS to permit or restrict current flow into or out of a battery. In some embodiments, a battery may be placed in a fully enabled state, a charge-enabled state, a discharge-enabled state, or a restricted state.

As further shown in FIG. 11, the series of acts 1100 includes an act 1130 of, during a charging condition, enabling charging of batteries having relatively lower energy levels while restricting charging of batteries having relatively higher energy levels by modifying the protection states. For example, the controller may enable charge paths for batteries in a lower-energy group while disabling or limiting charge paths for batteries in a higher-energy group to preferentially direct charge current.

As further shown in FIG. 11, the series of acts 1100 includes an act 1140 of, during a discharging condition, enabling discharging of batteries having relatively higher energy levels while restricting discharging of batteries having relatively lower energy levels by modifying the protection states. For example, the controller may enable discharge paths for batteries in a higher-energy group while restricting discharge paths for batteries in a lower-energy group to preferentially supply current.

As further shown in FIG. 11, the series of acts 1100 includes an act 1150 of identifying a candidate battery and comparing a battery parameter of the candidate battery to a reference battery parameter. For example, the candidate battery may be selected from a group of batteries that are not currently fully enabled, and the reference battery parameter may correspond to a parameter of a battery in a group of enabled batteries.

As further shown in FIG. 11, the series of acts 1100 includes an act 1160 of modifying a protection state of the candidate battery to permit participation when a difference between the parameters is within a threshold. For example, when the difference between the battery parameter of the candidate battery and the reference battery parameter is less than a predefined threshold, the controller may enable the candidate battery by modifying its protection state. If the difference exceeds the threshold, enabling may be delayed or performed after a transition sequence.

As further shown in FIG. 11, the series of acts 1100 includes an act 1170 of iteratively modifying protection states of the plurality of batteries to reduce imbalance. For example, the controller may repeat one or more of the acts described above to progressively enable additional batteries and reduce differences in battery parameters. In some embodiments, the iterative process may continue until the battery parameters converge within a predefined threshold while the battery bank remains in operation.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system for managing a battery bank, comprising:
a plurality of batteries, each battery associated with a battery management system (BMS) configured to control charge and discharge paths of the respective battery; and
a controller communicatively coupled to the plurality of batteries or to the BMS associated therewith, wherein the controller is configured to:
monitor one or more battery parameters associated with the plurality of batteries;
determine an imbalance condition among the plurality of batteries based on the monitored battery parameters;
assign the plurality of batteries into one or more groups based on relative values of the battery parameters;
control protection states of the plurality of batteries by selectively enabling or disabling charge paths and discharge paths of the batteries via the BMS;
during a charging condition, modify the protection states to enable charging of one or more batteries having relatively lower energy levels while restricting charging of one or more batteries having relatively higher energy levels;
during a discharging condition, modify the protection states to enable discharging of one or more batteries having relatively higher energy levels while restricting discharging of one or more batteries having relatively lower energy levels; and
iteratively modify the protection states of the plurality of batteries to reduce imbalance while the battery bank remains in operation.

2. The system of claim 1, wherein the protection states include a fully enabled state, a fully disabled state, a charge-enabled state, and a discharge-enabled state.

3. The system of claim 1, wherein the controller is configured to determine the charging condition or the discharging condition based on a plurality of current measurements over time or by measurements from an external device including at least one of a load or a charger.

4. The system of claim 1, wherein assigning the plurality of batteries into one or more groups includes grouping a first subset of batteries having relatively lower values of a battery parameter and a second subset of batteries having relatively higher values of the battery parameter.

5. The system of claim 1, wherein the controller is further configured to:
identify a candidate battery from a group of batteries having restricted participation; and
compare a battery parameter of the candidate battery to a reference battery parameter associated with a group of enabled batteries.

6. The system of claim 5, wherein the controller is configured to modify a protection state of the candidate battery to permit charging or discharging when a difference between the battery parameter of the candidate battery and the reference battery parameter is within a predefined threshold.

7. The system of claim 6, wherein the predefined threshold corresponds to a difference that limits current flow between batteries when the candidate battery is enabled.

8. The system of claim 5, wherein the candidate battery is selected based on having a battery parameter closest to the reference battery parameter but not greater than a difference threshold.

9. The system of claim 1, wherein the controller is configured to sequence changes in protection states of the plurality of batteries to limit transient current.

10. The system of claim 1, wherein the controller is configured to sequence transitions between protection states such that at least one battery remains in a fully enabled state or a discharge-enabled state to supply power to a load.

11. The system of claim 1, wherein controlling the protection states includes at least one of:
transmitting control commands to the BMS; or
modifying one or more external electrical conditions of the battery bank to influence operation of the BMS.

12. A method for managing a battery bank including a plurality of batteries, each associated with a battery management system (BMS), the method comprising:
monitoring one or more battery parameters associated with the plurality of batteries;
determining an imbalance condition based on the battery parameters;
assigning the plurality of batteries into one or more groups based on relative values of the
battery parameters;
controlling protection states of the plurality of batteries by selectively enabling or disabling charge paths and discharge paths of the batteries via the BMS;
during a charging condition, enabling charging of batteries having relatively lower energy levels while restricting charging of batteries having relatively higher energy levels by modifying the protection states;
during a discharging condition, enabling discharging of batteries having relatively higher energy levels while restricting discharging of batteries having relatively lower energy levels by modifying the protection states;
identifying a candidate battery and comparing a battery parameter of the candidate battery to a reference battery parameter;
modifying a protection state of the candidate battery to permit participation when a difference between the parameters is within a threshold; and
iteratively modifying protection states of the plurality of batteries to reduce imbalance.

13. The method of claim 12, wherein the reference battery parameter corresponds to a lowest voltage among a first group of batteries during a charging condition.

14. The method of claim 12, wherein the reference battery parameter corresponds to a highest voltage among a first group of batteries during a discharging condition.

15. The method of claim 12, further comprising selecting the candidate battery based on having a battery parameter closest to the reference battery parameter.

16. The method of claim 12, further comprising performing a transition sequence including one or more intermediate protection states prior to permitting participation of the candidate battery.

17. The method of claim 12, further comprising detecting an overcurrent condition and modifying protection states of one or more batteries to redistribute current.

18. The method of claim 12, wherein controlling protection states includes influencing operation of the BMS without direct communication by modifying external electrical conditions of the battery bank.

19. A mobile surveillance unit comprising:
a battery bank including a plurality of batteries, each battery associated with a battery management system (BMS); and
a controller configured to:
monitor one or more battery parameters;
control protection states of the plurality of batteries by selectively enabling or disabling charge paths and discharge paths via the BMS; and
balance the plurality of batteries by modifying the protection states to control participation of the batteries in charging and discharging based on the battery parameters.

20. The mobile surveillance unit of claim 19, wherein the controller is configured to maintain continuous power delivery while balancing by sequencing changes in protection states such that at least one battery remains enabled to supply power.
